(19) United States
(12) Patent Application Publication
(10) Pub. No.: US 2004/0078318 A1
(43) Pub. Date: Apr. 22, 2004

(54) System and method for facilitating loan provision

(76) Inventor: Hugh I. Miller, Woodbury, NY (US)

Correspondence Address: MORGAN & FINNEGAN, L.L.P., 345 Park Avenue, New York, NY, 10154-0053, US

(21) Appl. No.: 10/368,955

(22) Filed: Feb. 18, 2003

Related U.S. Application Data
(60) Provisional application No. 60/359,260, filed on Feb. 21, 2002.
(60) Provisional application No. 60/429,821, filed on Nov. 29, 2002.

(51) Int. Cl. G06F 17/60

(52) U.S. Cl. 705/38

(57) ABSTRACT

Systems and methods for facilitating various aspects of loan provision. For example, the execution of various loan-related tasks may be facilitated. As another example, the coordination of the efforts of individuals, groups, and/or departments involved in loan provision may be facilitated.

This application claims the benefit of U.S. Provisional Application No. 60/359,260, filed Feb. 21^{st}, 2002, and of U.S. Provisional Application No. 60/429,821, filed Nov. 27^{th}, 2002, both of which are incorporated herein by reference.

### FIELD OF INVENTION

This invention relates to systems and methods for handling loans.

### BACKGROUND INFORMATION

Loans can play an important role in benefiting society. For example, a home loan can provide the backbone for home ownership. Further, loans can stimulate economic growth. Home loans, for example, can stimulate economic growth by creating jobs for various individuals such as contractors, plumbers, electricians, landscapers, and/or others involved in home creation and/or maintenance. As another example, business loans can lead to the direct creation of jobs. As yet another example, loans can stimulate the growth of growth of communities by attracting families, businesses, and individuals.

However, loan provision can often be a complex process. For example, loan provision can require the performance of various operations by various individuals. Further, loan provision can require the collection, consideration, and maintenance of a variety of information.

Accordingly, there may be interest in technologies that facilitate loan provision.

### SUMMARY OF THE INVENTION

According to various embodiments of the present invention, there are provided systems and methods for facilitating various aspects of loan provision. For example, various embodiments facilitate the execution of various loan-related tasks.

As another example, various embodiments of the present invention facilitate the coordination of the efforts of individuals, groups, and/or departments involved in loan provision.

### BRIEF DESCRIPTION OF THE DRAWINGS

FIG. 1 shows exemplary software modules employable in embodiments of the present invention.

FIG. 2 is a flow chart showing exemplary steps performable by a primary processing module according to embodiments of the present invention.

FIG. 3 is a flow chart showing exemplary steps performable by a secondary processing module according to embodiments of the present invention.

FIG. 4 is a flow chart showing exemplary steps performable by a post-close operations module according to embodiments of the present invention.

FIG. 5 is a flow chart showing exemplary steps performable by a retail operations module according to embodiments of the present invention.

FIG. 6 shows an exemplary general purpose computer employable in embodiments of the present invention.

### DETAILED DESCRIPTION OF THE INVENTION

General Operation

According to various embodiments of the present invention, there are provided systems and methods for facilitating various aspects of loan provision.

For instance, various embodiments facilitate the execution of various loan-related tasks such as, for example, retailing, brokering, verifying licensure, credit checking, performing appraisal-related tasks, underwriting, performing loan scenario-related tasks, performing title-related tasks, determining of compliance with established loan guidelines, settling, warehousing, performing quality control-related tasks, servicing, and/or loan selling.

It is further noted that various embodiments of the present invention facilitate the coordination of the efforts of individuals, groups, and/or departments involved in loan provision such as, for example, telemarketers or other retailers, brokers, branch managers, account managers, account processors, underwriters, appraisers, appraisal reviewers, title searchers, settlement agents, quality control, warehousing, and/or loan servicers.

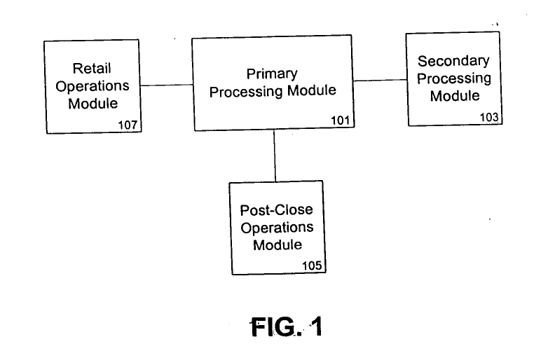

Shown in FIG. 1 are certain exemplary software modules employable in various embodiments of the present invention. The exemplary software modules shown are Primary Processing Module 101, Secondary Processing Module 103, Post-Close Operations Module 105, and Retail Operations Module 107. Such modules might, for example, operate on one or more servers. It is noted that, for various embodiments, alternate software module configurations might be employed.

Various aspects of the present invention will now be discussed in greater detail.

Primary Processing Module

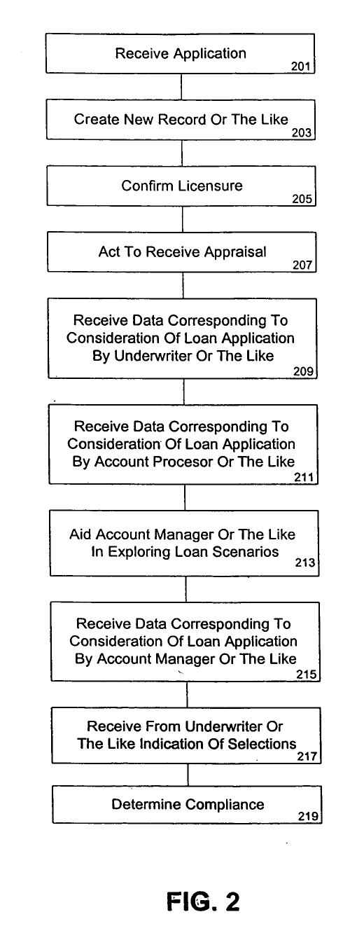

According to various embodiments of the present invention, a Primary Processing Module (PPM) 101 may operate to perform various operations associated with loan application processing. With reference to FIG. 2 it is noted that, as a first step in loan application processing, PPM 101 might receive a loan application submitted by one or more internal and/or external parties (step 201). Such internal and/or external parties might include, for example, brokers, loan officers, account executives, applicants, telemarketers, internal employees, external employees, and/or the like.

Loan applications could be submitted for processing in a number of ways. For instance, an application could be sent via electronic and/or physical delivery. Such electronic and/or physical delivery might involve the use of, for example, facsimile, conventional mail, courier, email, instant messaging, dispatch via one or more program modules and/or computers, and/or data entry. For various embodiments, one or more software modules might operate to receive a submitted application and to present it to PPM 101 in an appropriate format.

For embodiments where loan application submission is via facsimile, the one or more software modules might first interface with conventional facsimile reception software to receive image data corresponding to the faxed loan application. Such interfacing could be achieved, for instance using application scripting techniques known in the art. As specific examples, AppleScript or Visual Basic for Applications (VBA) might be employed. Next, the one or more software modules might apply optical character recognition techniques known in the art to extract from the image data the text represented therein.

It is noted that various embodiments of the present invention may employ a Broadcast System Module that allows any document, data, and/or the like to be transmitted electronically. The module could act to have transmission occur via one or more interfaces. Such interfaces could include, for example, email, facsimile, text messaging, a document generating system, and/or the like.

The Broadcast System Module could be employed to send to a specified recipient or group of recipients a customized and/or individualized document, message, and/or the like. In forming the body of the document, message, and/or the like, preformed text and imbedded tags might be employed. The tags could be appropriately populated by the module with specific content to yield a customized and/or individualized document, message, and/or the like.

For dispatch of the document, message, and/or the like, recipients and/or additional options could be specified. A user might make such specification, for example, via a GUI or the like of the sort noted above. Among available options might be, for example, a delivery and/or transmission time. It is noted that the Broadcast System Module might be implemented within a specific application and/or software module. Alternately, the module might be implemented as a separate application and/or software module.

After this, the one or more modules might act to parse from the text various data elements. For example, the one or more modules might act to parse from the text data including applicant names, social security numbers, and/or real estate property identifiers. The one or modules might next place the parsed data into a structured format. The structured format might be, for example, an XML (extensible markup language) data structure. Such an XML data structure might be structured in accordance with a predetermined schema. The one or more modules could then act to pass the parsed data to PPM 101.

For embodiments where submission is via conventional mail, the one or more modules might act in a manner analogous to that just discussed with respect to facsimile submission, but receive image data corresponding to the loan application, for instance, by interfacing with conventional scanning software. For various embodiments of the present invention, mailroom workers or the like could be instructed to provide loan applications received via conventional mail to a scanner from which the one or more modules, perhaps via interface with conventional scanning software, could receive image data.

For embodiments where submission is via email, the one or more modules might act in accordance with various protocols known in the art to receive from a mail server or the like to receive the email. In the case where the email is encrypted, the one or more modules could perform appropriate operations to perform decryption. Next, the one or more modules could act in a manner analogous to that described above with respect to facsimile submission to parse various data elements from the body of the email and/or from any attachments thereto, perhaps placing the parsed data into a structured format, and pass the parsed data to PPM 101.

For embodiments where submission is via one or more program modules and/or computers, the one or more program modules and/or computers could pass the application to PPM 101 via, for example, SOAP (Simple Object Access Protocol), RMI (Remote Method Invocation), JMS (Java Messaging Service), file transfer, HTTP (Hypertext Transfer Protocol), FTP (File Transfer Protocol), EDI (Electronic Data Interchange), email, instant messaging, and/or the like. The passed application could be in a structured format such as, for example, XML.

For embodiments where loan application submission is via data entry, PPM 101, perhaps with the assistance of one or more additional modules, might act to provide an a graphical user interface (GUI) or other interface whereby loan application information could be entered. According to various embodiments, PPM 101 might act to place entered loan application into a structured format such as XML.

The GUI functionality might be implemented via a dynamic webpage employing, for example, JSP (Java Server Pages), ASP (Active Server Pages), ASP.NET, PHP (PHP: Hypertext Preprocessor), CGI (Common Gateway Interface), and/or the like. Such a dynamic webpage could be accessible through use of a conventional web browser or the like directed to an appropriate URL (uniform resource locator). Such a webpage might be accessible via the Internet, or might be accessible only via a LAN (local area network), intranet, VPN (virtual private network), or the like. As another example, such GUI functionality might be implemented through use of a client application, such as, for instance, a Java or Net client application. Such a client application could interface with PPM 101 via SOAP, RMI, JMS, and/or the like.

Where such interface is provided by way of a dynamic webpage, internal and/or external parties wishing to submit a loan application could employ web browsing software with the URL (universal resource locator) corresponding to the dynamic webpage. Where such interface is provided by way of client software, internal and/or external parties wishing to submit a loan application could launch the client software, downloading it first if necessary. The client software could, as noted above, provide a GUI via which loan application information could be entered.

After receiving the loan application, PPM 101 might act to create, perhaps in an accessible store and/or database, a new record, file, or the like corresponding to the received loan application (step 203). Placed in the record or the like could be, for example, the received loan application data, the time/date when the loan application was received, an indication of the mode by which the application had been submitted (e.g., via client software), and/or the identity of the internal and/or external parties submitting the application. In various embodiments, the record or the like could be in a structured format such as, for example, XML.

As a next step, PPM 101 could act to determine if there were any pending loan applications associated with the same unique personal identifier (e.g., social security number) and/or unique business identifier (e.g., Federal Tax Identification Number) associated with the received loan application. The unique identifier associated with the received loan application might be extracted from the recorded data corresponding to the application. In the case where one or more such pending loan applications were determined to exist, PPM 101 could place indication of that determination in each record or the like corresponding to those pending loan applications, and in the record or the like corresponding to the received loan application.

Next, PPM 101 could determine if an appraisal has been received for any of those pending loan applications. In the case where such an appraisal had been received, PPM 101 could terminate processing with respect to the received loan application. PPM 101 might also act to have an explanation of why processing was terminated sent to the internal and/or external parties that submitted the loan application, to one or more applicants associated with the loan application, and/or to one or more other individuals. The explanation could be dispatched, for example, via email, fax, telephone call, and/or conventional letter, and might follow a form and/or script, the form and/or script perhaps being created by an administrator or other individual. The form and/or script could contain fields or the like into which the specific information (e.g., the name of applicants) could be placed. Accordingly, PPM 101 could act to populate any fields contained in the form and/or script, and then perform dispatch of the explanation.

The dispatch technique could depend upon the delivery mode employed for delivery of the explanation. For example, in the case where delivery was to be via email, PPM 101 could interface with a mail server or the like, perhaps using protocols known in the art in order to have the completed form and/or script dispatched to the appropriate individuals or individuals. As an exemplary alternative, PPM 101 might interface with a conventional email program using AppleScript, Visual Basic for Applications, or the like.

In the case where delivery was to be via facsimile, PPM 101 might interface with a conventional facsimile program, perhaps using AppleScript, Visual Basic for Applications, or the like in order to have the completed form and/or script dispatched to the appropriate individuals or individuals. Where an automated telephone call was to be employed, PPM 101 could inform an appropriate individual, such as an account manager or telemarketer, of the need to make the telephone call. PPM 101 might employ a GUI or the like of the sort noted above, email, instant messaging, and/or the like in informing the individual. Provided to the individual could be the telephone number or numbers that should be dialed, the names of the individual or individuals to be notified, and/or the completed form and/or script to be read to those individuals. The telephone numbers might be extracted from the received application data.

In the case where delivery was to be via conventional mail, PPM 101 could employ techniques known in the art to have the completed form and/or script printed out on a printer. One or more individuals could be employed to remove such completed forms/and or scripts from printers, and to send them out via conventional mail.

In the case where no pending loan applications were found to have the same unique identifier as the received application, or where such pending loan applications were found but were determined not to be associated with received appraisals, PPM 101 could act to confirm appropriate licensure for the internal and/or external parties that submitted the loan application (step 205).

In performing this operation, PPM 101 might first consult an accessible store containing licensure information in light of one or more identifiers associated with the internal and/or external parties that submitted the loan application. Such identifiers might be known from the received loan application data. It is noted that, in various embodiments, consultation of the store containing licensure information could involve consideration of licensure expiration dates, U.S. states where license is valid, and/or any allowable grace periods with regard to expired licenses.

In the case where consultation found the internal and/or external parties to be properly and currently licensed, processing of the loan application could continue. Where the consultation did not provide such a result, PPM 101 could inform one or more individuals of a need to perform an investigation regarding the licensing status of the internal and/or external parties that submitted the loan application, and to inform PPM 101 as to whether processing of the loan should proceed. The one or more individuals directed to perform the investigation might, for example, be associated with a business development department.

The one or more individuals could be informed of a need to perform the licensing investigation in a number of ways. For example, PPM 101 could maintain, perhaps in an accessible store, a task list on behalf of the one or more individuals, and could add to the task list an entry corresponding to the need to perform the licensing investigation. PPM 101 could present the task list to the one or more individuals in a number of ways. For instance, PPM 101 could present the task list via a GUI. Such GUI functionality might, for example, be provided by a dynamic webpage or client application of the sort described above.

In the case where the individual or individuals performing the research determined the licensing of the individual submitting the application to be acceptable, the individual or individuals could instruct PPM 101 that processing of the loan application should proceed. Otherwise, the individual or individuals could instruct PPM 101 that processing of the loan should terminate. PPM 101 might act to add to the record or the like one or more indications corresponding to the received instructions.

The individual or individuals might provide such instructions to PPM 101 in a number of ways. For example, the instructions could be provided via a GUI. Such a GUI or the like might, for instance, offer buttons or other GUI elements employable in indicating to PPM 101 whether or not processing of the loan application should proceed. Such GUI functionality could be implemented in a manner analogous to that discussed above. Accordingly, a dynamic webpage and/or a client application could be employed. For various embodiments, a single dynamic webpage and/or a client application could be employed for both presenting the task list and for allowing indication to PPM 101 of whether or not processing of the loan application should proceed.

In the case where PPM 101 received instruction that processing of the loan should terminate, PPM 101 could comply. In such a case, PPM 101 might also dispatch notification of such to one or more individuals in a manner analogous to that discussed above. In the case where PPM 101 received instruction that processing of the loan should continue, PPM 101 could act to receive an appraisal corresponding to the loan application (step 207). Such an appraisal might, for example, be an appraisal of a real estate property with respect to which a loan was being sought. PPM 101 might act to add to the record or the like one or more indications corresponding to the received appraisal. The process by which PPM 101 could act to request an appraisal will be discussed in greater detail below.

PPM 101 could next act to determine if a specific underwriter or the like had been assigned to the received loan application. Such a determination might be made, for example, via consultation of an accessible store. In the case where it was determined that the received loan application had been assigned to a specific underwriter or the like, PPM 101 could act to inform that underwriter or the like of a need to consider the loan application. Such functionality could be implemented in a number of ways. For example, in various embodiments PPM 101 could maintain a task list for each underwriter or the like that was, perhaps via a GUI or the like of the sort noted above, accessible by that underwriter or the like. For such embodiments, PPM 101 could add to the task list of the appropriate underwriter or the like an indication corresponding to the received loan application. Such functionality could be implemented in a manner analogous to that discussed above.

In the case where it was determined that the received loan application had not been assigned to a specific underwriter or the like, PPM 101 might act to associate the loan application with an underwriting work queue. For example, PPM 101 could, in a in a manner analogous to that discussed above, maintain a task list on behalf of a plurality of underwriters or the like that was, perhaps via a GUI or the like of the sort noted above, accessible by those underwriters or the like. For such embodiments, PPM 101 could add to the task list an indication corresponding to the received loan application. In various embodiments, a GUI or the like of the sort noted above could allow an underwriter or the like to indicate that a task list entry be moved from the work queue task list to a personal underwriter task list maintained for him by PPM 101.

It is noted that, in the case where it was determined that the received loan application had not been assigned to a specific underwriter or the like, PPM 101 might instead act to select an underwriter or the like to handle the loan application and an appropriate entry to that individual's task list. Selection could be performed with respect to a number of algorithms. For example, PPM 101 could examine the task lists of a number of underwriters or the like, and add the entry to the task list of the individual having the least number of task list entries.

An underwriter or the like having in his task list an entry corresponding to the received loan application could act to determine if preliminary approval should be given. In various embodiments, PPM 101 could, perhaps via a GUI of the sort noted above, allow the underwriter or the like access to all or certain portions of the record or the like and/or received loan application data. In various embodiments, PPM 101 could provide various functions to aid the underwriter or the like in making the determination. Such functions could be made available to the user, for instance, via a GUI of the sort noted above.

Among functions made available to the underwriter or the like could be, for example, the ability to request one or more credit reports corresponding to the loan application. Such functionality might, for example, be offered to the underwriter or the like by PPM 101 via a GUI or the like of the sort noted above.

An underwriter or the like might be able to request a credit report, for example, by employing appropriate GUI elements. Via the GUI elements the underwriter or the like might, in requesting a credit report, specify information such as the type of credit report. Available credit report types might include, for example, “Equifax,” “Trans Union”, “Experian,” or “tri-merged”.

In honoring such a request, PPM 101 might interface with one or more appropriate credit servers or the like employing appropriate techniques known in the art. In the interfacing, PPM 101 might send various data extracted from the record or the like and/or from received loan application data. In response, PPM 101 could receive data corresponding to the requested report. PPM 101 might act to perform additional processing on data received from such credit servers or the like. PPM 101 could then act, perhaps via the GUI or the like of the sort noted above, to provide data corresponding to the requested report to the underwriter or the like. In various embodiments, PPM 101 might act to add to the record or the like one or more indications corresponding to the received credit report data.

After determining if preliminary approval should be granted, the underwriter or the like could notify PPM 101 of the decision (step 209). The underwriter or the like might provide the notification, for example, via a GUI of the sort noted above. Included in the notification could be, for example, indication of one or more preliminary stipulations. PPM 101 might act to add to the record or the like one or more indications corresponding to the received notification.

In various embodiments, the underwriter or the like might act to have documentation regarding the decision created. For example, PPM 101, perhaps via the GUI or the like, could allow the underwriter or the like to request that an appropriate document to be created. Among the documents available for creation could be a preliminary approval document. Such a preliminary approval document could include indication of any preliminary stipulations specified by the underwriter or the like.

Document creation could be performed by PPM 101 in a manner analogous to that discussed above. PPM 101 might also, perhaps via the GUI, allow the underwriter or the like to specify that a created document be printed and/or sent to one or more specified individuals. PPM 101 could offer various options for sending a document such as, for example, fax and conventional mail. Such fax and mail transmission could be implemented by PPM 101 in a manner analogous to that discussed above. In various embodiments, PPM 101 might act to add to the record or the like one or more indications corresponding to such created documentation.

Upon receiving indication that preliminary approval had not been granted, PPM 101 could terminate processing of the loan. PPM 101 might also dispatch notification of such to one or more individuals in a manner analogous to that discussed above. In the case where PPM 101 receives indication that preliminary approval had been granted, PPM 101 could act to have the loan application considered by an account processor or the like. In a manner analogous to that discussed above, PPM 101 might act to place an appropriate indication in a maintained task list corresponding to a particular account processor or the like. In a manner also analogous to that discussed above, PPM 101 might instead act to associate the loan application with an account processor work queue.

An account processor having such an indication in his task list could act to perform tasks such as verification of information contained in the loan application, requesting title information corresponding to the loan application, and/or performing clearance with respect to preliminary stipulations specified by the underwriter or the like. In various embodiments, PPM 101 could, perhaps via a GUI of the sort noted above, allow the account processor or the like access to all or certain portions of the record or the like, and/or of the received loan application data. Further, for various embodiments PPM 101 could, perhaps via a GUI or the like of the sort noted above, provide various functions to aid the account processor or the like in performing his tasks. Among functions made available to the account processor or the like could be, for example, the ability to perform a title request. Such title request functionality will be discussed in greater detail below.

Upon completing his tasks, the account processor or the like could submit his results to PPM 101 (step 211). Submission could, for instance, be via a GUI or the like of the sort discussed above. PPM 101 might act to add to the record or the like one or more indications corresponding to the received results. It is noted that PPM 101 might, perhaps in a manner analogous to that discussed above, act to forward the results to one or more individuals. For instance, PPM 101 might act to forward the results to an account manager or the like.

Next, PPM 101 could act to have the loan application considered by an account manager or the like. In a manner analogous to that discussed above, PPM 101 might act to place an appropriate indication in a maintained task list corresponding to a particular account manager or the like, or to associate the loan application with an account manager work queue.

An account manager having in his task list an entry corresponding to the loan application could act to perform, perhaps specified, various tasks. For instance, the account manger or the like might communicate with the internal and/or external parties to verify information and/or work out issues. The account manager could also act to work out various loan scenarios and choose one or more that he felt to be most appropriate. The account manger or the like might act to discuss various potential scenarios with the internal and/or external parties, and/or with the loan applicant or applicants. In a manner analogous to that discussed above, PPM 101 might allow the account manager or the like access to all or certain portions of the record or the like and/or received loan application data.

It is further noted that, perhaps in a manner analogous to that described above, PPM 101 could provide various functions to aid the account manager in performing his duties. For instance PPM 101, perhaps with the assistance of one or more software modules, could act to provide functionality whereby the account manager or the like could explore various loan scenarios (step 213). Such functionality will be discussed in greater detail below.

After the account manager or the like has chosen one or more scenarios that he felt to be most appropriate, he could, perhaps via a GUI or the like of the sort noted above, provide indication of such to PPM 101 (step 215). PPM 101 might act to add to the record or the like one or more indications corresponding to the received indication.

Next, PPM 101 could, perhaps in a manner analogous to that discussed above, place in the task list corresponding to the underwriter or the like an indication that he should make a choice from among the various scenarios chosen by the account manager and/or the like. It might be further indicated that he should specify finalized stipulations. PPM 101 might employ the GUI or the like in presenting to the underwriter or the like the one or more scenarios chosen by the account manager or the like.

The underwriter or the like could, perhaps via the GUI or the like, provide indications of his selections to PPM 101 (step 217). PPM 101 might act to add to the record or the like one or more indications corresponding to the received indications. The underwriter or the like might also, perhaps via the GUI or the like, request that one or more appropriate documents corresponding to his selections be created. The underwriter or the like might additionally specify recipients for the created documents. Such recipients might include, for example, the internal and/or external parties. The documentation creation and dispatch functionality might be implemented in a manner analogous to that discussed above. In various embodiments, PPM 101 might act to add to the record or the like one or more indications corresponding to the documents.

Next, PPM 101 might act to determine if the proposed loan scenario, stipulations, and/or the like were in accordance with predetermined guidelines (step 219). Such functionality might be implemented, for instance, by having PPM 101 review the received loan application data and/or various data generated during loan application processing (e.g., specified scenarios and/or received appraisals) in view of the guidelines. The guidelines might, for example, be available to PPM 101 via an accessible store. The submitted loan application and/or various data generated during loan application processing might, for example, be available to PPM 101 via the record or the like. It is noted that the guidelines might be chosen by a financial expert or the like. In various embodiments, such guidelines might be submitted to PPM 101 via a GUI or the like of the sort noted above.

In the case where PPM 101 determined that the proposed loan scenario, stipulations, and/or the like were not in compliance with the predetermined guidelines, PPM 101 could, perhaps in a manner analogous to that discussed above, terminate processing of the loan application. In such a case, PPM 101 might also dispatch notification of such to one or more individuals in a manner analogous to that discussed above.

In the case where PPM 101 determined that the proposed loan scenario, stipulations, and/or the like were in compliance with the predetermined guidelines, PPM 101 might notify Secondary Processing Module (SPM) 103 to perform operations with respect to the loan application. Such notification might be performed, for example via SOAP, JMS, RMI, or the like.

It is noted that, for various embodiments of the present invention, an individual (e.g., an internal and/or external party associated with submitting the loan application) might be able to indicate to PPM 101 that processing of the loan should terminate. Such and indication might, for example, be dispatched via a GUI or the like of the sort noted above. Upon receiving such a request PPM 101, perhaps after verifying the identity of the requestor and/or his authority to make the request, could comply. PPM 101 might additionally dispatch notification of the termination to one or more individuals in a manner analogous to that discussed above.

In various embodiments, PPM 101 might act to solicit such a request. Such solicitation might involve, for example, displaying a textual message via a GUI or the like of the sort noted above. A system administrator or other individual could set various options regarding when such solicitations should be mage and/or to whom such solicitations should be sent. For instance, it might be specified that the solicitation should happen with a specified frequency and/or in response to specified events. As a specific example, it might be indicated that the internal and/or external parties corresponding to a particular loan application be so solicited after the corresponding account manager or the like has chosen the one or more loan scenarios he felt to be most appropriate.

It is noted that, for various embodiments, modules such as PPM 101 might aid in communications between various individuals involved in various steps of loan application processing. Such individuals might include, for example, internal and/or external parties associated with application submission, applicants or the like, underwriters or the like, account processors or the like, and account managers or the like. For example, a messaging system might be provided whereby a first individual could enter a textual message via a GUI or the like of the sort noted above, and instruct PPM 101 to deliver it to, for instance, a specified one or more individuals. PPM 101 might implement delivery, for example, by having the message display to the appropriate or more individuals or the like via one or more GUIs or the like of the sort noted above. It is noted that the various individuals involved in various steps of loan application processing might communicate in additional ways such as, for example, in-person and/or via telephone, facsimile, email, instant messaging, and/or the like.

For various embodiments of the present invention, the module could act to place in the record or the like corresponding to a loan application appropriate notation corresponding to communications among the individuals involved in the processing of the application. Such notation might include, for example, the text of messages sent via the a messaging system of the sort just described. Also included might be the text of facsimiles, emails, instant messaging messages, and/or the like sent. As yet another example, telephone call transcripts might be included. Included also could be information corresponding to, for example, dates, senders, and receipts associated with such communications. It is noted that, in various embodiments, modules other than PPM 101 could provide analogous functionality. For instance, Secondary Processing Module 103 could provide analogous functionality with respect to its operations.

Secondary Processing Module

As noted above, PPM 101 might inform Secondary Processing Module (SPM) 103 of a need to perform operations with respect to a loan application. As a first step, SPM 103 might act to request that the account manager or the like and/or the account processor or the like perform various operations with respect to the application. For instance, it could be specified that the account processor receive, request, and/or process documentation regarding the stipulations corresponding to the loan application. Accordingly, in a manner analogous to that discussed above w, SPM 103 might place in the task list corresponding to the account manager or the like and/or the task list corresponding to the account processor or the like an appropriate indication.

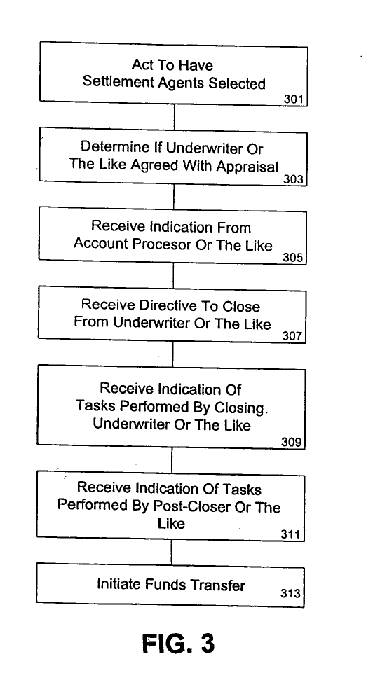

With reference to FIG. 3, it is noted that SPM 103 could next act to have settlement agents selected with respect to the loan application, and might act to add to the record or the like one or more indications corresponding to information received in response to the request (step 301). The process by which SPM 103 could act to request such selection will be discussed in greater detail below.

After this, SPM 103 could act to determine if the underwriter or the like agreed with the appraisal received with respect to the loan application (step 303). Accordingly, SPM 103 might, in a manner analogous to that discussed above, place in the task list corresponding to the underwriter or the like a corresponding indication. In various embodiments, the underwriter or the like could view the appraisal by way of a GUI or the like. In reply, the underwriter or the like could, perhaps via the GUI or the like, provide his response to SPM 103. SPM 103 might act to add to the record or the like one or more indications corresponding to the received response.

In the case where the underwriter or the like indicated that he did not agree with the appraisal, SPM 103 could act to have the appraisal considered by an appraisal reviewer or the like. Accordingly, SPM 103 could, in a manner analogous to that discussed above, place an appropriate indication in a maintained task list corresponding to a particular appraisal reviewer or the like. In a manner also analogous to that discussed above, SPM 103 might instead act to associate the loan application with an appraisal reviewer work queue.

An appraisal reviewer having in his task list such an indication could perform various tasks to reviewer the appraisal, perhaps ordering additional information via a variety of sources (e.g., telephone and/or the Internet). In various embodiments SPM 103 could, perhaps in a manner analogous to that discussed above, provide various functions to aid the appraisal reviewer or the like in performing his tasks. Upon completing his tasks, the appraisal reviewer or the like could submit his results to SPM 103. Included in the results could be, for example, review range, variances, tolerance result, name of original appraiser, and/or date of review. Submission could, for instance, be via a GUI or the like of the sort discussed above. SPM 103 could, in turn, add to the record or the like an indication corresponding to the received results.

Next, SPM 103 might act to determine if the underwriter or the like, in light of the results of the appraisal review, wished for processing of the loan application to continue. Accordingly, SPM 103 might, in a manner analogous to that discussed above, place in the task list corresponding to the underwriter or the like a corresponding indication. In various embodiments, the underwriter or the like could view the appraisal review results by way of the GUI or the like. In reply, the underwriter or the like could, perhaps via the GUI or the like, provide his response to SPM 103. SPM 103 might act to add to the record or the like one or more indications corresponding to the received response.

In the case where the underwriter or the like indicated that processing of the loan application should terminate, SPM 103 could comply in a manner analogous to that discussed above, perhaps also dispatching notification regarding the termination to one or more individuals in a manner analogous to that discussed above.

In the case where the underwriter or the like agreed to the appraisal or in the case where the underwriter or the like originally disagreed with the appraisal but agreed after appraisal review the application processing should continue, SPM 103 might request that the account manager or the like do a review of the application. Accordingly, SPM 103 could, in a manner analogous to that discussed above, place an appropriate indication in the task list corresponding to the account manger or the like. SPM 103 could facilitate the review by allowing the account manger or the like, perhaps via the GUI, to view various elements of the record, received application data, and/or or the like. As alluded to above, included in this record or the like might be record of communications among various individuals.

As a next step, SPM 103 could await indication from the account processor or the like that all necessary stipulation information had been received and that any other issues that needed to be addressed had been resolved. SPM 103 could additionally await for directive from the underwriter or the like to commence closing. Such indications and directives might, for example, be provided to SPM 103 via GUI in a manner analogous to that described above. The underwriter or the like might dispatch closing directive after performing certain tasks such as, for example, determining that various stipulations had been met, and/or waiving various stipulations.

Upon receiving the indication from the account processor or the like (step 305) and the directive from the underwriter or the like (step 307), SPM 103 could add one or more corresponding indications to the record or the like. Next, SPM 103 could act to have the loan application processed by a closing underwriter or the like.

Accordingly, SPM 103 could, in a manner analogous to that discussed above, place an appropriate indication in a maintained task list corresponding to a particular closing underwriter or the like. In a manner also analogous to that discussed above, SPM 103 might instead act to associate the loan application with an closing underwriter work queue. The task list or work queue entry could indicate, for example, that any final stipulations should be secured, that final approval to close should be secured, and/or that approval to fund should be secured. A closing underwriter or the like having such an entry in his task list could act to perform the indicated tasks. Upon completing his tasks, the closing underwriter or the like could submit, perhaps via a GUI or the like of the sort noted above, his results to SPM 103 (step 309). SPM 103 could, in turn, add to the record or the like an indication corresponding to the received results.

Next, SPM 103 could act to have the loan application processed by a post-closer or the like. Accordingly, SPM 103 could, in a manner analogous to that discussed above, place an appropriate indication in a maintained task list corresponding to a particular post-closer or the like. In a manner also analogous to that discussed above, SPM 103 might instead act to associate the loan application with a post-closing work queue. The task list or work queue entry could indicate, for example, a need to ready closing stipulation documentation and/or any other documentation required for closing. A post-closer or the like having such an entry in his task list could act to perform the indicated tasks. Upon completing his tasks, the post-closer or the like could, perhaps via a GUI or the like of the sort noted above, submit his results to SPM 103 (step 311). SPM 103 could, in turn, add to the record or the like an indication corresponding to the received results.

Next, perhaps after receiving indication that closing was proceeding, SPM 103 could act to initiate funds transfer (step 313). Such indication might be received in a number of ways. For instance, such an indication might be received via a GUI or the like of the sort noted above.

Initiation of funds transfer could be implemented, for example, by interfacing with one or more banking server or the like to initiate electronic funds transfer (EFT) via techniques known in the art. Accordingly, an EFT might, for example, be executed for the loan amount specified by the received loan application data and/or the record or the like, with the target being the one or more applicants specified by the received loan application data and/or the record or the like. As another example, EFT might be executed with the target being the individual or entity specified by the record or the like to be selling that which the loan application was submitted to purchase. As a specific example, where the loan application was submitted for purchase of a real estate property, EFT might be executed with the target being the individual, individuals, or entity selling the property.

Next, SPM 103 might notify Post-Close Operations Module (PCM) 105 of a need to perform operations with respect to the closed loan application. Such notification might be performed, for example via SOAP, JMS, RMI, or the like.

Post-Close Operations Module

As noted above, SPM 103 might inform Post-Close Operations Module (PCM) 105 of a need to perform operations with respect to the closed loan application.

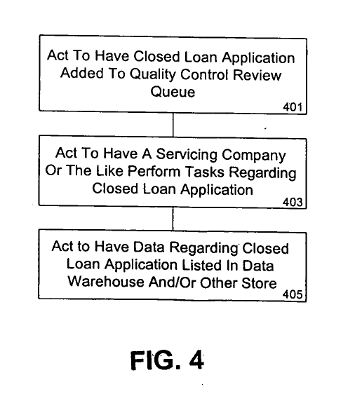

With reference to FIG. 4 it is noted that, as a first step, PCM 105 might act to have the closed loan application added to a pool from which closed loan applications are selected for quality control review (step 401). Such quality control review might include, for instance, verifying that the closed loan application is in compliance with various regulatory requirements (e.g., state, federal, and/or local requirements. As another example, such quality control review might include checking the closed loan application for accuracy and/or completeness, and/or performing follow-up with respect to trailing documentation.

PCM 105 might act to have the loan application added to such a pool, for example, by placing an appropriate indication in a maintained task list corresponding to a particular loan quality control officer or the like in a manner analogous to that discussed above. Alternately, PCM 105 might act in a manner analogous to that discussed above to associate the loan application with an appraisal reviewer work queue.

A loan quality control officer or the like having such an indication in his task list might act to perform tasks with respect to the closed loan application including, for example, one or more of those described above. It is noted that, in various embodiments, the loan quality control officer or the like having such an indication in his task list might only act to perform the tasks upon determining that and/or receiving a notification that the closed loan application had been selected for quality control review. Such selection might, for example, be in compliance with established guidelines (e.g., an agency or investor guideline that a specified percentage of closed loan applications be quality control reviewed). The loan quality control officer might, for example, receive such a notification via a GUI or the like of the sort discussed above. Upon completing his tasks, the loan quality control officer or the like could submit his results to PCM 105. Submission could, for instance, be via a GUI or the like of the sort discussed above. PCM 105 could, in turn, add to the record or the like an indication corresponding to the received results.

Next, PCM 105 could act to have various tasks regarding the closed loan application performed by a servicing company or the like (step 403). Such tasks might include, for example, collection of payments, performance of property inspections, performance of insurance-related tasks, and/or payment of taxes.

PCM 105 might act to have a servicing company or the like perform such tasks, for example, by interfacing with one or more computers associated with the servicing company or the like. Such interface might involve, for example, SOAP, RMI, JMS, and/or the like. In various embodiments, the interfacing might include the, perhaps protected (e.g., encrypted), transfer of various data corresponding to the closed loan application and/or its corresponding record or the like. As another example, PCM 105 might act in a manner analogous to that discussed above to place an indication in a maintained task list corresponding to or more individuals that the tasks necessary to secure the services of a servicing company or the like be performed.

Where tasks are performed by a serving company or the like, PCM 105 might receive back data relating to those tasks. PCM 105 might act to add such received data to the record. Such receipt of data might occur in a number of ways such as, for example, via electronic and/or physical delivery. As a specific example, PCM 105 might receive such data from one or more computers associated with the servicing company or the like. Such receipt might involve, for example, the use of SOAP, RMI, and/or JMS. As another specific example, such data might be received in a manner such as conventional mail, facsimile, email, telephone, face-to-face communications, and/or the like, and dispatched to PCM 105 in a manner analogous to that discussed above.

As a next step, PCM 105 might act to have various data regarding the closed loan application listed in a data warehouse and/or other store (step 405). Accordingly, PCM 105 might act to interface with the data warehouse or other database and/or store via, for example, SOAP, RMI, and/or JMS. SQL might also be employed.

In various embodiments, the data warehouse and/or other store might be employed in selling loans. Such loans might, for example be available for sale both individually and in bulk. Accordingly, one or more individuals acting to sell loans might, for example, have access to data held in the data warehouse and/or or the store regarding one or more closed loan applications. Such access might, for example, be via a GUI or the like of the sort noted above, and might involve SOAP, RMI, JMS, and/or the like. SQL might also be employed.

Appraisal, Title, and Settlement Agent Operations

As alluded to above, PPM 101 might act to request from a third party an appraisal and/or a title. As also noted above, SPM 103 might act to request selection of settlement agents. Various aspects of these operations will now be discussed in greater detail.

In requesting an appraisal, PPM 101 might first consult an accessible store to learn the identity of and/or data relating to a predetermined appraisal company or the like. The predetermined appraisal company or the like might be selected, for example, by a system administrator, bank officer, and/or the like. PPM 101 might receive data relating to selection of a predetermined appraisal company or the like, for example via a user's entries use of GUI or the like of the sort noted above.

It is noted that, for various embodiments, multiple predetermined appraisal companies or the like could be selected, with selection criteria being submitted to PPM 101 for each one. The selection criteria could thus indicate under what circumstances an indicated appraisal company should be employed. Such selection criteria could include, for instance, price of property, type of property (e.g., single family home, apartment building, hotel, store, or factory), and/or location. For such embodiments, in consulting the accessible store, PPM 101 could considered submitted criteria in learning of the appropriate predetermined appraisal company or the like.

Having learned of the predetermined appraisal company or the like to use for the loan application, PPM 101 could act to interface with one or more computers associated with the appraisal company or the like. PPM 101 might learn of various data necessary to interface with the one or more computers (e.g., network addresses or URLs) via the accessible store. Interface might be, for example, involve the use of SOAP, RMI, and/or JMS. In various embodiments, the interfacing might include the, perhaps protected (e.g., encrypted), transfer of various data corresponding to the loan application and/or its corresponding record or the like.

In response, PPM 101 could receive from the one or more computers various data relating to a performed appraisal. As noted above, PPM 101 might act to add to the record or the like one or more indications corresponding to the received appraisal data. PPM 101 might additionally act, perhaps via a GUI or the like of the sort noted above, to present one or more individuals with information relating to the appraisal.

In various embodiments, PPM 101 could allow an individual, perhaps after viewing information relating to the appraisal, to request an additional appraisal. The individual might submit the request to PPM 101 via a GUI or the like. Such an additional appraisal might, for example, be ordered for the purpose of verifying the received appraisal. It is noted that, in various embodiments, an additional appraisal might be a limited appraisal. Accordingly, the submitted request could include information such as, for example, appraisal type. For various embodiments, an individual might need to have at least a certain authority level to be able to submit such a request. For such embodiments, PPM 101, upon receiving such a request might consult user records or the like to determine if the individual had authority to make the request. Such permission might, for example, be set by a system administrator or the like.

It is noted that, in various embodiments, PPM 101 might act to automatically request an additional appraisal when certain conditions were met. The conditions could be set, for example, by a system administrator, bank officer, and/or the like, perhaps via a GUI or the like of the sort noted above. PPM 101 might learn of such conditions, for instance, by consulting an accessible store.

As described above, PPM 101 could act to request an appraisal from a predetermined appraisal company or the like. In various embodiments, one or more individuals might be able to act to override the predetermined choice and to submit an alternate selection. Such overriding and submission might, for example, be via a GUI or the like of the sort noted above. For certain of such embodiments an individual might need to have at least a certain authority level to be able to perform such an operation. For such embodiments, PPM 101 might act in a manner analogous to that described above to determine if an individual performing the operation had sufficient authority to do so.

Turning to request of title, it is noted that PPM 101 might act in a manner analogous to that discussed above with respect to request of appraisal. Accordingly, PPM 101 could first to learn the identity of and/or data relating to a predetermined title company or the like. In a manner further analogous to that discussed above, the predetermined title company or the like might be selected, for example, by a system administrator, bank officer, and/or the like. Further analogously, for various embodiments, multiple title companies or the like could be selected.

Next PPM 101 could, having learned of the predetermined title company or the like to use for the loan application, act in a manner analogous to that discussed above to interface with one or more computers associated with the title company or the like. In response, PPM 101 could act in a manner analogous to that discussed above to receive from the one or more computers various data relating to the title request, and perhaps to add to the record or the like one or more indications corresponding to the received data. Further analogously, PPM 101 might additionally act to present one or more individuals with information relating to the data received in response to the title request.

It is noted that, in various embodiments of the present invention, additional requests to third parties could be made in a manner analogous to that discussed with respect to request of title and request of appraisal. For instance, request could be made for flood certification, life-of-loan flood certification, AVM (automated value model) determination, income verification, and/or identity verification.

Turning now to requesting selection of settlement agents, it is noted that SPM 103 might first, in a manner analogous to that discussed above, place in the task list corresponding to the account manager or the like an indication that selection of settlement agent needed to be performed. The account manager could respond by employing a GUI or the like of the sort noted above to perform selection. More specifically, SPM 103 could, via the GUI or the like, allow the account manager or the like to search and/or browse among pre-selected settlement agents. SPM 103 could know of the available settlement agents by accessing an accessible store. The pre-selected settlement agents might be chosen by a system administrator, bank officer, and/or the like in a manner analogous to that discussed above.

In searching and/or browsing among pre-selected settlement agents, the account manager or the like might be able to search by criteria such as, for example, name, city, and/or state. The account manager or the like might be able to view information regarding the settlement agents such as, for example, name, address, telephone number, and/or facsimile number. The viewed information might also indicate whether or not EFT information was known for a particular settlement agent.

Having searched and/or browsed among pre-selected settlement agents, the account manager or the like could select one for use. The account manager or the like could indicate his selection to SPM 103, for example, via the GUI. In various embodiments, the account manager or the like could, perhaps using the GUI or the like, provide an address for the closing. Such entry might only be performed in the case where the closing address was different from the address specified for the selected settlement agents.

Upon receiving indication of the selection, SPM 103 might add to the record or the like an indication corresponding to the received indication. Next, SPM 103 might take steps to inform the selected settlement agents of their selection. Such functionality could be implemented in a number of ways. For example, SPM 103 could inform one or more individuals, perhaps via a GUI or the like of the sort noted above, of a need to contact the settlement agents with regard to their selection. As another example, SPM 103 could interface with one or more computers associated with the settlement agents and dispatch an indication regarding to the selection. Such one or more computers might, for example, maintain task lists or the like for the settlement agents. Such interface might, for example, involve SOAP, RMI, and/or JMS. As yet another example, SPM 103 might have email, conventional mail, and/or the like dispatched to inform the settlement agents of their selection. Such functionality might be implemented in a manner analogous to that discussed above.

In various embodiments, SPM 103 may allow one or more individuals to edit information regarding pre-selected settlement agents. Such an individual might be able to perform such editing, for instance, via a GUI or the like of the sort noted above. Editable information with respect to a pre-selected settlement agent might include, for instance, name, city, state, address, telephone number, facsimile number, and/or EFT-related information. For various embodiments, the information editable by an individual might depend on his authority level. For instance, individuals of less than a certain authority level might only be able to edit name, telephone number, and facsimile number. For such embodiments, SPM 103 might, in a manner analogous to that discussed above, consult user records or the like to determine the information allowed to be edited by a particular individual.

Loan Scenario Module

As noted above, in various embodiments PPM 101, perhaps with the assistance of one or more software modules, might act to provide functionality whereby an account manager or the like, and/or other individual, could explore various loan scenarios. Such functionality will now be discussed in greater detail.

For various embodiments, PPM 101 could, as a first step in providing such functionality, extract from the record or the like corresponding to the loan application under consideration, and/or from the received loan application data, various data elements regarding the application. Such data elements might include, for example, various data elements relating to the loan applicant or applicants, various data elements relating to that for which the loan is being sought (e.g., a real estate property), various data elements relating to the loan type being sought, and/or the like.

For example, data elements relating to relating to the loan applicant or applicants might include credit report data, income documentation, job history information, and/or the like. As a specific example, where loan a loan is being sought to purchase a real estate property, data elements relating to relating to that for which the loan is being sought might include property type, property occupation status, location, and/or the like. As yet another example, data elements relating to the loan type being sought might include indication of whether a purchase loan or a refinance loan, or another type of loan was being sought.

PPM 101, for various embodiments, might not act to extract such data elements from the record or the like corresponding to the loan application under consideration, and/or from received loan application data. Instead, PPM 101 might query the account manager or the like, and/or one or more other individuals, for such data elements. Accordingly, PPM 101 might provide a GUI or the like of the sort noted above whereby such data elements could be entered.

After receiving or extracting the data elements, PPM 101 could act to pass the data elements to a Loan Scenario Module (LSM). The passing might, for example, involve the use of SOAP, RMI, JMS, and/or the like. After receipt, the LSM might act to determine various possible loan scenario properties sets with respect to the data elements. Such loan scenario properties could include, for instance, loan rates, loan prepayment penalties, and/or loan stipulations. Such functionality might be implemented in a number of ways. For example, the LSM might consult an accessible store.

For example, the consulted store might correlate sets of data element values with sets of loan scenario properties. In various embodiments, the store could list multiple loan scenario property sets for a particular set of data elements values. As a specific example, the store might correlate a data element set consisting of a certain credit report value, a certain income value, a certain property type value, a certain property location value, and a certain loan type value with one or more loan scenario property sets each consisting of a certain interest rate value, a certain prepayment penalty value, and one or more certain stipulation values. In various embodiments, where multiple sets of loan scenario properties are correlated with a particular set of data elements, the multiple sets of loan scenario properties might differ in perceivable ways. As a specific example, one such set of loan scenario properties could differ from a second such set of loan scenario properties by offering a higher interest rate but lower prepayment penalty.

As another example, the consulted store might alternately or additionally include rule sets that take data elements of the sort noted above as inputs and produce loan scenario properties sets as outputs. It is noted that the rule sets might act so as to yield multiple loan scenario property sets as output for a given set of data element inputs. Where the store contains both rules sets and correlations, the rule sets might take into account the correlations. Accordingly, the LSM might consult a store containing such rule sets but no such correlations. As yet another example, loan scenario property determination could involve the LSM considering both correlations and rule sets.

The consulted store could be populated in a number of ways. For instance, the contents of such a store could be chosen by a system administrator, bank officer, financial expert, and/or other individual. The chosen contents might be entered into the store via a GUI or the like of the sort noted above, perhaps through the action of a system administrator or the like.

Having determined one or more loan scenario property sets with respect to the data elements, the LSM might next act to ascertain whether or not the determined loan scenarios were in compliance with one or more sets of regulations. Such regulations might, for example, be state, local, and/or federal regulations. The LSM might ascertain compliance by consulting an accessible store containing data relating to such regulations, and examining the determined scenarios in light of the data. In the case where a determined was found not to be compliant, that scenario could be removed from consideration. Alternately, such a scenario could be flagged for later consideration. Such later consideration will be described below.

As a next step, the LSM could pass the determined loan scenarios to PPM 101. PPM 101 could then display the determined scenarios to the account manager or the like, perhaps via a GUI or the like of the sort noted above. In various embodiments, PPM 101 might act to add to the record or the like one or more indications corresponding to the determined scenarios. In various embodiments the account manger or the like, perhaps via the GUI or the like, could provide to PPM 101 notes regarding particular determined scenarios, and/or could act to specify one or more determined scenarios to be better than or worse than other determined scenarios. PPM 101 could act to add to the record or the like one or more indications corresponding to such notes and/or specifications.

In the case where certain scenarios were flagged as noted above, each such scenario could be displayed to the account manger or the like with an indication that the scenario was not compliant. In various embodiments, the account manger or the like could, perhaps via the GUI, act to override the LSM's determination that the scenario was not compliant. Such functionality might be useful, for example, where the account manger or the like believed the LSM to have been incorrect in its determination of non compliance. For such embodiments, PPM 101 could act to determine if a user attempting to perform such an override had authority to do so. Such a determination might be done in a manner analogous to that discussed above.

For various embodiments, the account manager or the like could have the LSM determine hypothetical scenarios. Such functionality might be implemented by allowing the account manger or the like to enter hypothetical data elements in a manner analogous to that discussed above. Various scenarios could then be determined, and perhaps presented to the account manager or the like, in a manner analogous to that discussed above. For various embodiments, the account manager or the like might indicate with data element entry that the elements were hypothetical. Alternately or additionally, in displaying resulting scenarios to the account manager or the like, the scenarios could be labeled as hypothetical.

Retail Operations Module

According to various embodiments of the present invention, Retail Operations Module (ROM) 107 may act to provide various operations relating to loan retail.

As a first step in providing such functionality, Retail Operations Module (ROM) 107 might act to inform a retailer (e.g., telemarketer or the like) of a need to perform tasks such as, for example, making a retail call to a potential loan applicant, collecting any information necessary for prequalification from the potential applicant, and/or seeking permission from the potential applicant to run a credit check. ROM 107 might know of the information necessary for prequalification, for example, via consultation of an accessible store.

Accordingly, ROM 107 could, in a manner analogous to that discussed above, place an appropriate indication in a maintained task list corresponding to a particular telemarketer or the like. In a manner also analogous to that discussed above, SPM 103 might instead act to associate the loan application with a telemarketer work queue.

A telemarketer having such an indication in his task list could act to perform the specified operations. In placing the retail call, the telemarketer might employ a predictive dialer known in the art. The predictive dialer might have access to a telemarketing database or the like. The telemarketing database or the like could be populated with data purchased from an appropriate vendor.

Upon choosing a potential applicant, the predictive dialer could provide ROM 107 with various data regarding the chosen individual. The predictive dialer might employ SOAP, RMI, and/or JMS in providing the data. Upon receiving the data, ROM 107 could act to create in an accessible store a record or the like corresponding to the potential applicant. Such creation might be performed in a manner analogous to that discussed above. It is noted that, in certain embodiments, ROM 107 might receive the data from other than the predictive dialer. For example, the data might be provided by one or more software modules associated with the database or the like, the one or more modules perhaps communicating with ROM 107 via SOAP, RMI, JMS, and/or the like. As yet another example, the telemarketer or the like might provide such information to ROM 107 via a GUI or the like of the sort noted above.

Upon establishing telephonic contact with the potential applicant chosen by the predictive dialer, the telemarketer or the like could query the potential applicant to obtain data necessary for prequalification. In various embodiments, a GUI or the like of the sort noted above could be presented to the telemarketer by ROM 107. The telemarketer could employ the GUI or the like to provide to ROM 107 received data necessary for prequalification. In various embodiments, ROM 107 might act to guide the telemarketer in procuring such data by presenting to the telemarketer, perhaps via the GUI or the like, indication of the data to be collected. Accordingly, the GUI or the like might present to the telemarketer or the like an indication of each data item to be collected and, next to each indication, a GUI field or other element via which the telemarketer or the like could provide the data item.

Further upon establishing telephonic contact with the potential applicant, the telemarketer or the like could seek permission to run a credit check. The telemarketer or the like could employ the GUI or the like in informing ROM 107 of the potential applicant's decision.

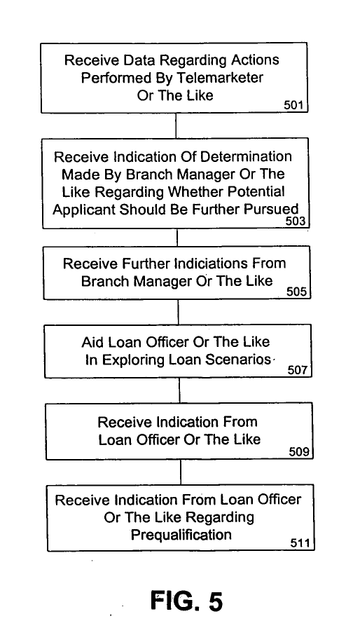

With reference to FIG. 5, it is noted that, upon receiving the results of the actions performed by the telemarketer or the like, ROM 107 could act to add to the record or the like a corresponding indication (step 501). Next, ROM 107 could act to determine if all information necessary for prequalification had been collected. ROM 107 might do this, for example, by considering the collected data in light of the information known to be necessary for prequalification.

In the case where ROM 107 determined that not all necessary data had been collected, the module could terminate processing, perhaps sending a corresponding notification to one or more individuals. For instance, a corresponding notification might be sent to the telemarketer or the like. ROM 107 might additionally act to add to the record or the like an indication that callback should be performed with respect to the potential applicant. ROM 107 might then, at a later time, act in a manner analogous to that discussed above to inform a telemarketer of a need to perform callback with respect to the potential applicant.

In the case where ROM 107 determined that all necessary data had been collected, the module might consult the data collected by the telemarketer to determine if permission to run a credit check had been procured. In the case where such permission had been received, ROM 107 might act, perhaps in a manner analogous to that described above, to have a credit check run. ROM 107 might act to add to the record or the like received data yielded by the credit check.

Next, ROM 107 could act to have a branch manager or the like consider the potential applicant and make a determination as to whether or not the potential applicant should be further perused Accordingly, ROM 107 could, perhaps in a manner analogous to that discussed above, place a corresponding entry in a maintained task list corresponding to the branch manager or the like. The branch manager or the like could make the determination and, perhaps via a GUI or the like of the sort noted above, inform ROM 107 of his decision (step 503). To aid the branch manager or the like in making his determination, ROM 107 might allow him, perhaps via the GUI, to view one or more items contained in the record or the like. In various embodiments, the branch manager or the like might be able to inform ROM 107 that no decision could be made because more information was needed. In providing such an indication to ROM 107, the branch manager or the like might specify what additional information was required.

After receiving a response from the branch manager or the like, ROM 107 could add to the record or the like one or more indications corresponding to the response. In the case where the branch manager or the like indicated that the potential applicant should not be further pursued, ROM 107 could, perhaps in a manner analogous to that discussed above, cease processing with respect to the potential applicant. ROM 107 might additionally, perhaps in a manner analogous to that discussed above, dispatch notification regarding the termination to one or more individuals.

In the case where the branch manager or the like indicated that no decision could be made because more information was needed, ROM 107 could act to add to a maintained task list corresponding to a particular telemarketer or the like an indication that further, perhaps specified, information should be gathered concerning the potential applicant. The particular telemarketer or the like could procure the additional information and provide it to ROM 107, perhaps in a manger analogous to that discussed above. In response, ROM 107 could add to the record or the like one or more indications corresponding to the received data. ROM 107 could then, perhaps in a manner analogous to that discussed above, inform the branch manager or the like of a need to reconsider the potential applicant.

In the case where the branch manager or the like indicated that the potential applicant should be further pursued, ROM 107 could inform the branch manager or the like of a need to perform tasks such as, for example assigning a grade to the potential applicant, placing comments regarding the potential applicants, and/or choosing a loan officer or the like to handle further consideration of the potential applicant. Accordingly, ROM 107 could, in a manner analogous to that discussed above, place an appropriate indication in the task list corresponding to the branch manger or the like. The branch manager or the like could, perhaps via a GUI or the like of the sort noted above, provide the requested information to ROM 107 (step 505). In response, ROM 107 could add to the record or the like one or more indications corresponding to the received response.

Next, ROM 107 could act to have the specified loan officer or the like to perform tasks such as, for example, initial exploration of various loan scenarios with respect to the potential applicant and/or determining whether or not the potential applicant should be further pursued. Accordingly, ROM 107 could, perhaps in a manner analogous to that discussed above, place a corresponding entry in a maintained task list corresponding to the loan officer or the like. ROM 107 could, in a manner analogous to that discussed above with respect to PPM 101, communicate with an LSM to allow the loan officer or the like to explore various loan scenarios (step 507). Operation of the LSM could be analogous to that discussed above with reference to an account officer. In various embodiments, the LSM could act in a manner analogous to discussed above with reference to exploration of hypothetical scenarios. ROM 107 might, in a manner analogous to that discussed above, act to add to the record or the like one or more indications corresponding to the determined scenarios.

The loan officer or the like could, perhaps via a GUI or the like of the sort noted above, inform ROM 107 of his decision regarding whether or not the potential applicant should be further pursued, and ROM 107 could add a corresponding indication to the record or the like (step 509). In the case where the loan officer or the like indicated that the potential applicant should not be further pursued, ROM 107 could, perhaps in a manner analogous to that discussed above, cease processing with respect to the potential applicant, perhaps dispatching notification regarding the termination to one or more individuals in a manner analogous to that discussed above.

In the case where the loan officer or the like indicated that the potential applicant should be further pursued, ROM 107 could act, perhaps in a manner analogous to that described above, to have a tri-merged credit check run. ROM 107 could then add to the record or the like received data yielded by the credit check.

Next, ROM 107 could act to have the specified loan officer or the like perform tasks such as, for example, further exploration of various loan scenarios with respect to the potential applicant and/or determining whether or not the potential applicant is prequalified. Such further exploration could be specified to take into account the results of the tri-merged credit report. Accordingly, ROM 107 could, perhaps in a manner analogous to that discussed above, place a corresponding entry in a maintained task list corresponding to the loan officer or the like. ROM 107 could, in a manner analogous to that discussed above, allow the loan officer or the like to explore various loan scenarios, and/or act to add to the record or the like one or more indications corresponding to the determined scenarios.

The loan officer or the like could, perhaps via a GUI or the like of the sort noted above, inform ROM 107 of his decision regarding whether or not the potential applicant is prequalified, and ROM 107 could add a corresponding indication to the record or the like (step 511).

In the case where the loan officer or the like indicated that the potential applicant was not prequalified, ROM 107 could, perhaps in a manner analogous to that discussed above, cease processing with respect to the potential applicant, perhaps dispatching notification regarding the termination to one or more individuals in a manner analogous to that discussed above.

In the case where the loan officer or the like indicated that the potential applicant was prequalified, ROM 107 could, in the manner discussed above, act to pass to PPM 101 a loan application corresponding to the potential applicant. PPM 101 could, with receipt, act in a manner analogous to that discussed above.

Hardware and Software

Certain procedures and the like described herein may be executed by or with the help of computers. The phrases “computer”, “general purpose computer”, and the like, as used herein, refer but are not limited to a processor card smart card, a media device, a personal computer, an engineering workstation, a PC, a Macintosh, a PDA, a computerized watch, a wired or wireless terminal, a server, a network access point, a network multicast point, or the like, perhaps running an operating system such as OS X, Linux, Darwin, Windows CE, Windows XP, Palm OS, Symbian OS, or the like, perhaps with support for Java or .Net.

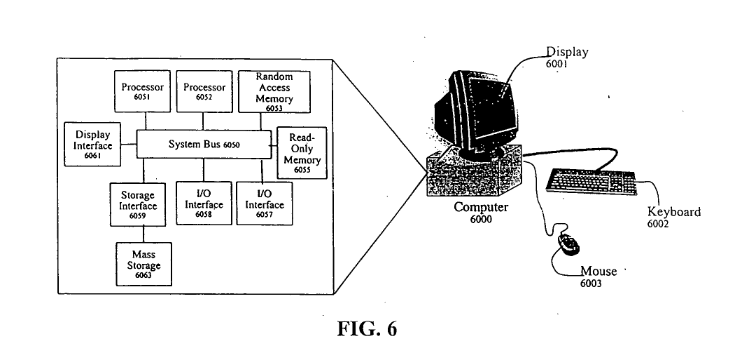

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Accordingly, exemplary computer 6000 as shown in FIG. 6 includes system bus 6050 which operatively connects two processors 6051 and 6052, random access memory 6053, read-only memory 6055, input output (I/O) interfaces 6057 and 6058, storage interface 6059, and display interface 6061. Storage interface 6059 in turn connects to mass storage 6063. Each of I/O interfaces 6057 and 6058 may be an Ethernet, IEEE 1394, IEEE 1394b, IEEE 802.11a, IEEE 802.11b, IEEE 802.11g, IEEE 802.16a, IEEE P802.20, Bluetooth, terrestrial digital video broadcast (DVB-T), satellite digital video broadcast (DVB-S), digital audio broadcast (DAB), general packet radio service (GPRS), universal mobile telecommunications service (UMTS), or other interface known in the art.

Mass storage 6063 may be a hard drive, optical drive, or the like. Processors 6057 and 6058 may each be a commonly known processor such as an IBM or Motorola PowerPC, an AMD Athlon, an AMD Opteron, an Intel ARM, an Intel XScale, a Transmeta Crusoe, or an Intel Pentium. Computer 6000 as shown in this example also includes an display unit 6001, a keyboard 6002 and a mouse 6003. In alternate embodiments, keyboard 6002, and/or mouse 6003 might be replaced and/or augmented with a touch screen, pen, and/or keypad interface. Computer 6000 may additionally include or be attached to card readers, DVD drives, floppy disk drives, and/or the like whereby media containing program code may be inserted for the purpose of loading the code onto the computer.

In accordance with the present invention, a computer may run one or more software modules designed to perform one or more of the above-described operations, the modules being programmed using languages such as Java, Objective C, C, C#, and/or C++ according to methods known in the art. Corresponding program code might be placed on media such as, for example, DVD, CD-ROM, and/or floppy disk. It is noted that any described division of operations among particular software modules is for purposes of illustration, and that alternate divisions of operation may be employed. Accordingly, operations discussed as being performed by one software module might instead be performed by a plurality of software modules. Similarly, operations discussed as being performed by a plurality of modules might instead be performed by a single module.

Further, although embodiments of the invention disclose certain software modules as operating on certain devices, in alternate embodiments these modules might be distributed to run on other devices than those stated. For example, operations disclosed as being performed by a particular computer might instead be performed by a plurality of computers. It is further noted that, in various embodiments, grid computing techniques may be employed.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

What is claimed is:

1. A method for facilitating loan provision, comprising:
receiving a loan application;
receiving data corresponding to an evaluation of said application;
facilitating formulation of one or more loan scenarios corresponding to said application;
receiving notification of fulfillment of one or more stipulations, said one or more stipulations relating to a chosen one of said one or more loan scenarios; and
facilitating closing for a loan corresponding to the chosen one of said one or more loan scenarios.

2. The method of claim 1, further comprising facilitating performance of quality control operations corresponding to said loan.

3. The method of claim 1, further comprising warehousing data corresponding to said loan.

4. The method of claim 1, further comprising facilitating the sale of said loan.

5. The method of claim 1, further comprising ordering title information corresponding to said loan.

6. The method of claim 1, further comprising ordering appraisal information corresponding to said loan.

7. The method of claim 1, wherein the data corresponding to the evaluation includes one or more stipulations.

8. The method of claim 1, wherein said evaluation is an underwriter evaluation.

9. The method of claim 1, further comprising facilitating selection of closing agents.

10. The method of claim 1, further comprising initiating funds dispensing corresponding to said loan.

11. The method of claim 10, wherein initiating comprises initiation of electronic funds transfer.

12. The method of claim 1, further comprising performing verification of licensure for one or more individuals associated with said loan provision.

13. The method of claim 1, further comprising determining if said loan is in compliance with predetermined guidelines.

14. The method of claim 1, wherein facilitating formulation comprises determining a rate for each of said one or more loan scenarios.

15. The method of claim 14, wherein rate determination involves consulting correlations.

16. The method of claim 14, wherein rate determination involves consulting rules.

17. The method of claim 1, wherein facilitating formulation comprises determining a prepayment penalty for each of said one or more loan scenarios.

18. The method of claim 17, wherein prepayment penalty determination involves consulting correlations.

19. The method of claim 17, wherein prepayment penalty determination involves consulting rules.

20. The method of claim 1, wherein facilitating formulations comprises determining stipulations for each of said one or more loan scenarios.

21. The method of claim 20, wherein stipulation determination involves consulting correlations.

22. The method of claim 20, wherein stipulation determination involves consulting rules.

23. The method of claim 1, further comprising facilitating a credit check.

24. The method of claim 1, wherein said loan application is received from an internal party.

25. The method of claim 1, wherein said loan application is received from an external party.

26. The method of claim 1, further comprising facilitating contact with an individual predicted to require loaned funds.

27. The method of claim 26, further comprising facilitating determination of desirability of said individual as a loan applicant.

28. The method of claim 1, further comprising receiving data corresponding to a request submitted to a third party.

29. The method of claim 28, wherein the data corresponding to the request comprises appraisal data.

30. The method of claim 28, wherein the data corresponding to the request comprises title data.

31. The method of claim 28, wherein the data corresponding to the request comprises flood certification data.

32. The method of claim 28, wherein the data corresponding to the request comprises life-of-loan flood certification data.

33. The method of claim 28, wherein the data corresponding to the request comprises automated value model determination data.

34. The method of claim 28, wherein the data corresponding to the request comprises income verification data.

35. The method of claim 28, wherein the data corresponding to the request comprises identify verification data.

36. A method for facilitating loan provision, comprising:
informing an individual of a need to contact a potential loan applicant;
receiving an evaluation corresponding to said potential loan applicant;
facilitating formulation of one or more loan scenarios corresponding to said potential loan applicant; and
receiving a prequalification status corresponding to said potential loan applicant.

37. The method of claim 36, wherein said individual is a telemarketer.

38. The method of claim 36, wherein said evaluation includes a grade.

39. The method of claim 36, wherein said evaluation includes one or more comments.

40. The method of claim 36, wherein facilitating formulation comprises determining a rate for each of said one or more loan scenarios.

41. The method of claim 40, wherein rate determination involves consulting correlations.

42. The method of claim 40, wherein rate determination involves consulting rules.

43. The method of claim 36, wherein facilitating formulation comprises determining a prepayment penalty for each of said one or more loan scenarios.

44. The method of claim 43, wherein prepayment penalty determination involves consulting correlations.

45. The method of claim 43, wherein prepayment penalty determination involves consulting rules.

46. The method of claim 36, wherein facilitating formulations comprises determining stipulations for each of said one or more loan scenarios.

47. The method of claim 46, wherein stipulation determination involves consulting correlations.

48. The method of claim 46, wherein stipulation determination involves consulting rules.

49. The method of claim 36, further comprising facilitating consideration of a loan application corresponding to said potential loan applicant.

50. A system for facilitating loan provision, comprising:
a memory having program code stored therein; and
a processor operatively connected to said memory for carrying out instructions in accordance with said stored program code;
wherein said program code, when executed by said processor, causes said processor to perform the steps of:
receiving a loan application;
receiving data corresponding to an evaluation of said application;
facilitating formulation of one or more loan scenarios corresponding to said application;
receiving notification of fulfillment of one or more stipulations, said one or more stipulations relating to a chosen one of said one or more loan scenarios; and
facilitating closing for a loan corresponding to the chosen one of said one or more loan scenarios.

51. The system of claim 50, wherein said processor further performs the step of facilitating performance of quality control operations corresponding to said loan.

52. The system of claim 50, wherein said processor further performs the step of warehousing data corresponding to said loan.

53. The system of claim 50, wherein said processor further performs the step of facilitating the sale of said loan.

54. The system of claim 50, wherein said processor further performs the step of ordering title information corresponding to said loan.

55. The system of claim 50, wherein said processor further performs the step of ordering appraisal information corresponding to said loan.

56. The system of claim 50, wherein the data corresponding to the evaluation includes one or more stipulations.

57. The system of claim 50, wherein said evaluation is an underwriter evaluation.

58. The system of claim 50, wherein said processor further performs the step of facilitating selection of closing agents.

59. The system of claim 50, wherein said processor further performs the step of initiating funds dispensing corresponding to said loan.

60. The system of claim 59, wherein initiating comprises initiation of electronic funds transfer.

61. The system of claim 50, wherein said processor further performs the step of performing verification of licensure for one or more individuals associated with said loan provision.

62. The system of claim 50, wherein said processor further performs the step of determining if said loan is in compliance with predetermined guidelines.

63. The system of claim 50, wherein facilitating formulation comprises determining a rate for each of said one or more loan scenarios.

64. The system of claim 63, wherein rate determination involves consulting correlations.

65. The system of claim 63, wherein rate determination involves consulting rules.

66. The system of claim 50, wherein facilitating formulation comprises determining a prepayment penalty for each of said one or more loan scenarios.

67. The system of claim 66, wherein prepayment penalty determination involves consulting correlations.

68. The system of claim 66, wherein prepayment penalty determination involves consulting rules.

69. The system of claim 50, wherein facilitating formulations comprises determining stipulations for each of said one or more loan scenarios.

70. The system of claim 69, wherein stipulation determination involves consulting correlations.

71. The system of claim 69, wherein stipulation determination involves consulting rules.

72. The system of claim 50, wherein said processor further performs the step of facilitating a credit check.

73. The system of claim 50, wherein said loan application is received from an internal party.

74. The system of claim 50, wherein said loan application is received from a an external party.

75. The system of claim 50, wherein said processor further performs the step of facilitating contact with an individual predicted to require loaned funds.

76. The system of claim 75, wherein said processor further performs the step of facilitating determination of desirability of said individual as a loan applicant.

77. The system of claim 50, further comprising receiving data corresponding to a request submitted to a third party.

78. The system of claim 77, wherein the data corresponding to the request comprises appraisal data.

79. The system of claim 77, wherein the data corresponding to the request comprises title data.

80. The system of claim 77, wherein the data corresponding to the request comprises flood certification data.

81. The system of claim 77, wherein the data corresponding to the request comprises life-of-loan flood certification data.

82. The system of claim 77, wherein the data corresponding to the request comprises automated value model determination data.

83. The system of claim 77, wherein the data corresponding to the request comprises income verification data.

84. The system of claim 77, wherein the data corresponding to the request comprises identify verification data.

85. A system for facilitating loan provision, comprising:
a memory having program code stored therein; and
a processor operatively connected to said memory for carrying out instructions in accordance with said stored program code;
wherein said program code, when executed by said processor, causes said processor to perform the steps of:
informing an individual of a need to contact a potential loan applicant;
receiving an evaluation corresponding to said potential loan applicant;
facilitating formulation of one or more loan scenarios corresponding to said potential loan applicant; and
receiving a prequalification status corresponding to said potential loan applicant.

86. The system of claim 85, wherein said individual is a telemarketer.

87. The system of claim 85, wherein said evaluation includes a grade.

88. The system of claim 85, wherein said evaluation includes one or more comments.

89. The system of claim 85, wherein facilitating formulation comprises determining a rate for each of said one or more loan scenarios.

90. The system of claim 89, wherein rate determination involves consulting correlations.

91. The system of claim 89, wherein rate determination involves consulting rules.

92. The system of claim 85, wherein facilitating formulation comprises determining a prepayment penalty for each of said one or more loan scenarios.

93. The system of claim 92, wherein prepayment penalty determination involves consulting correlations.

94. The system of claim 92, wherein prepayment penalty determination involves consulting rules.

95. The system of claim 85, wherein facilitating formulations comprises determining stipulations for each of said one or more loan scenarios.

96. The system of claim 95, wherein stipulation determination involves consulting correlations.

97. The system of claim 95, wherein stipulation determination involves consulting rules.

98. The system of claim 85, wherein said processor further performs the step of facilitating consideration of a loan application corresponding to said potential loan applicant.
